(19) United States
(12) Patent Application Publication
(10) Pub. No.: US 2024/0196302 A1
(43) Pub. Date: Jun. 13, 2024

(54) METHOD FOR ACTIVATING AT LEAST ONE FUNCTIONALITY OF GATEWAY EQUIPMENT

(71) Applicant: Orange, Issy-les-Moulineaux (FR)

(72) Inventor: Cédric BERTOLUS, CHATILLON CEDEX (FR)

(21) Appl. No.: 18/532,968

(22) Filed: Dec. 7, 2023

(30) Foreign Application Priority Data
Dec. 7, 2022 (FR) 2212863

(51) Int. Cl. H04W 40/20; H04W 40/00; H04W 52/02

(52) U.S. Cl. CPC H04W 40/20; H04W 40/005; H04W 52/0206; H04W 88/16

(57) ABSTRACT

A method for activating at least one functionality of gateway equipment providing the interface between a wide area network and a local area network, the functionality being related to the local area network. The method includes, at an electronic device connected to the wide area network, the activation via the wide area network of the at least one functionality related to the local area network, when location information from at least one mobile communication terminal associated with the gateway equipment is representative of a geographic proximity of the mobile communication terminal with the gateway equipment.

### CROSS-REFERENCE TO RELATED APPLICATIONS

This application claims foreign priority to French Patent Application No. 2212863, entitled “METHOD FOR ACTIVATING AT LEAST ONE FUNCTIONALITY OF GATEWAY EQUIPMENT” and filed Dec. 7, 2022, the content of which is incorporated by reference in its entirety.

### BACKGROUND

### Technical Field

The development lies in the field of communication networks, and more particularly local communication networks implemented by means of gateway type electronic equipment. More particularly, the development relates to techniques allowing to promote energy savings within such networks.

### Prior Art

In the current economic, political and environmental context, controlling energy consumption has become a major issue, both at the collective and individual level.

As such, the electricity consumption of electronic devices that equip most homes (television, computer, refrigerator, etc.) is particularly scrutinized, in that it represents a significant part of the total electricity consumption of a home, and in that areas for improvement to optimize the consumption of such equipment exist.

Studies have for example shown that a major part of the electricity consumption of a domestic gateway—more commonly called a “box” or “internet box”, used to provide Internet access to the various terminals and connected objects in the home (computers, tablet, smartphone, etc.)—is carried out when the gateway is not used, that is to say when the gateway is connected and available, but it is not requested and no data passes therethrough.

Faced with this situation, the operators who market this equipment have developed solutions aimed at reducing their electricity consumption, in particular by allowing the user to deactivate certain functionalities of the gateway when they wish. This involves, for example, by providing dedicated buttons on the device and/or a graphical interface for manually configuring operating time slots, to offer the user the possibility of placing the gateway in a general state of more or less deep sleep, or to temporarily deactivate certain targeted functionalities such as Wi-Fi.

Despite these efforts, it is clear that the rate of adoption by users of these energy saving features remains very low. One of the main reasons is that these existing solutions are still perceived as too restrictive, particularly when the user needs to access gateway functionalities previously deactivated in this context. For example, in the potentially common case where a user wishes to connect to their Wi-Fi network during a time slot during which this functionality has been programmed to be deactivated, they are forced to perform an action—for example move to the room where their home gateway is installed to press a button—to reactivate the functionality in question. Moreover, even after performing this action, the functionality is not necessarily immediately available: reactivating certain functionalities can indeed take time—for example, exiting a deep sleep of the gateway is often slow and laborious, and can last several tens of seconds—access times that many users are no longer willing to endure. This friction in the use of these functions and the repetition of such situations can cause a certain frustration among users, who are then reluctant to continue using the energy saving mechanisms made available to them. As a result, said energy saving mechanisms are in fact used very little or not at all.

There is therefore a need for a solution allowing to improve existing energy saving functionalities at gateway type equipment, in particular by making the operations of reactivating deactivated functionalities more transparent and less restrictive for users.

### SUMMARY

The present technique allows to propose a solution aiming at overcoming certain disadvantages of the prior art. According to one aspect, the present technique relates indeed to a method for activating at least one functionality of gateway equipment providing the interface between a wide area network and a local area network, said functionality being related to said local area network. Such a method comprises, at an electronic device connected to said wide area network, the activation via said wide area network of said at least one functionality related to said local area network, when location information from at least one mobile communication terminal associated with said gateway equipment is representative of a geographic proximity of said mobile communication terminal with said gateway equipment.

In this way, it is possible to automatically and transparently restore for the user (that is to say without friction) functionalities of a local area network which had previously been deactivated (for energy saving purposes for example), for these features to be active when the user is likely to need them. The main obstacles to the adoption by users of energy saving solutions offered by operators who market gateway equipment are thus removed.

In a particular embodiment, said functionality belongs to the group comprising:
an exit from a sleep state of said gateway equipment; and/or
an activation of at least one wireless access point at said gateway equipment.

In this way, the present technique allows, transparently for the user, to bring the gateway equipment out of a sleep state in order to make the local area network available, and/or to activate a wireless interface of the gateway equipment (typically the Wi-Fi interface) in order to make the wireless local area network available.

In a first particular embodiment, said location information is in the form of data indicative of proximity, received by said electronic device from said communication terminal, confirming said geographic proximity of said mobile communication terminal with said gateway equipment.

In a second particular embodiment, said location information is in the form of geographic coordinates of said mobile communication terminal received by said electronic device from said mobile communication terminal, and said geographic proximity of said mobile communication terminal with said gateway equipment is established by the electronic device when said geographic coordinates are representative of a presence of said mobile communication terminal in a geographic reference zone previously determined and associated with said gateway equipment.

According to a particular feature of this second embodiment, said geographic reference zone is determined automatically based on an address associated with said gateway equipment.

According to a particular feature of this second embodiment, said geographic reference zone is a circular zone the center of which corresponds to a geographic position of said gateway equipment, and the radius of which is previously determined.

In a third particular embodiment, said location information is in the form of data representative of a current attachment of said mobile communication terminal to at least one relay antenna of known geographic position within a cellular network comprising said at least one relay antenna, received by said electronic device from said communication terminal or from third-party equipment of an operator of said cellular network, and said geographic proximity of said mobile communication terminal with said gateway equipment is established by the electronic device when said data are representative of a current attachment of said mobile communication terminal to at least one previously determined reference relay antenna of said cellular network.

According to a particular feature of this third embodiment, said at least one reference relay antenna is determined automatically based on an address associated with said gateway equipment and/or based on a prior identification of at least one relay antenna to which the mobile communication terminal is attached when said mobile communication terminal is connected to a wireless local area network provided by said gateway equipment.

According to another aspect, the present technique also relates to an electronic device for activating at least one functionality of gateway equipment providing the interface between a wide area network and a local area network, said electronic device being connected to said wide area network and said functionality being related to said local area network. Such an electronic device comprises means for activating said at least one functionality related to said local area network, implemented when location information from at least one mobile communication terminal associated with said gateway equipment is representative of a geographic proximity of said mobile communication terminal with said gateway equipment.

The means of said electronic device can be adapted to the implementation of any of the embodiments of the method of the present application.

According to another aspect, the proposed technique also relates to a mobile communication terminal associated with gateway equipment providing the interface between a wide area network and a local area network, said mobile communication terminal being configured to transmit to an electronic device according to any one of the embodiments described above location information representative of a geographic proximity of said mobile communication terminal with said gateway equipment.

According to another aspect, the proposed technique also relates to a computer program product downloadable from a communication network and/or stored on a computer-readable medium and/or executable by a microprocessor, comprising program code instructions for executing a method for activating at least one functionality of gateway equipment as described above, when executed on a computer.

The proposed technique also relates to a computer-readable recording medium on which is recorded a computer program comprising program code instructions for the execution of the steps of the method as described above, in any one of its embodiments.

Such a recording medium can be any entity or device capable of storing the program. For example, the medium may include a storage means, such as a ROM, for example a CD ROM or a microelectronic circuit ROM, or else a magnetic recording means, for example a USB key or a hard disk.

On the other hand, such a recording medium may be a transmissible medium such as an electrical or optical signal, which may be conveyed via an electrical or optical cable, by radio or by other means, so that the computer program it contains can be executed remotely. The program according to the development can in particular be downloaded onto a network, for example the Internet network.

The different embodiments mentioned above can be combined with each other for the implementation of the development.

### BRIEF DESCRIPTION OF THE DRAWINGS

Other features and advantages of the development will appear more clearly upon reading the following description of a preferred embodiment, given by way of a simple illustrative and non-limiting example, and the appended drawings, among which:

FIG. 1 illustrates an example of an environment wherein the proposed technique is implemented, in a particular embodiment;

FIG. 2 illustrates the main steps of the method for activating at least one functionality of gateway equipment, in a particular embodiment of the proposed technique;

FIG. 3a shows a first example of determining a geographic proximity of a mobile communication terminal with gateway equipment, in a particular embodiment of the proposed technique;

FIG. 3b shows a second example of determining a geographic proximity of a mobile communication terminal with gateway equipment, in a particular embodiment of the proposed technique;

FIG. 4 describes a simplified architecture of an electronic device for implementing the proposed technique, in a particular embodiment.

### DETAILED DESCRIPTION OF CERTAIN ILLUSTRATIVE EMBODIMENTS

The present application allows to overcome some of the aforementioned disadvantages.

In all the figures in this document, elements and steps of the same nature are designated by the same reference.

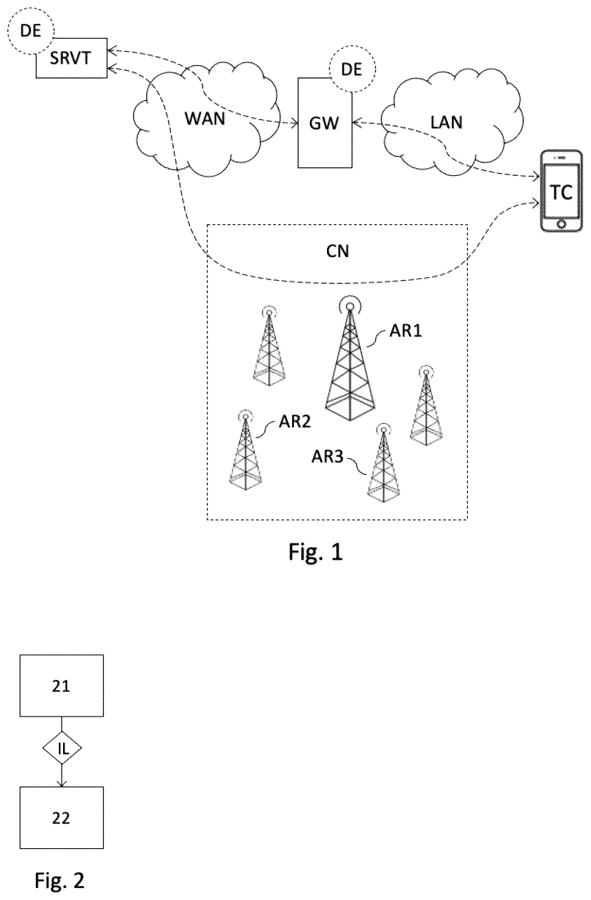

The present technique is located in a global context of energy saving objective, and is implemented in an environment as illustrated in relation to FIG. 1, wherein a gateway equipment GW (also sometimes called more simply “gateway” in the rest of the document) is used to interface between a local area network LAN and a wide area network WAN. More particularly, the local area network LAN is typically implemented thanks to the functionalities offered by the gateway equipment GW (Ethernet interfaces, Wi-Fi interfaces, router, etc.), and the wide area network WAN is conventionally the Internet network. The gateway GW thus allows different communication terminals (smartphones, tablets, computers, connected television, connected objects, etc.) connected to the local area network LAN to access the wide area network WAN. Some of these terminals, such as the communication terminal TC illustrated in FIG. 1, are wireless communication terminals, specifically designed for use in mobility situations. Such mobile communication terminals (of which smartphones are a typical example) are not required to be permanently connected to a local area network, also they generally have additional communication interfaces (in addition to the wireless communication interfaces of short or medium range Wi-Fi type) allowing them to access the wide area network WAN even when they are not connected to the local area network LAN provided by the gateway GW. These additional communication interfaces are typically in the form of cellular communication interfaces (2G, 3G, 4G, 5G, etc.) allowing in particular the mobile communication terminal TC to access the wide area network WAN via a cellular network CN comprising a multitude of relay antennas (AR1, AR2, AR3, etc.) ensuring coverage of a territory.

In a particular embodiment, a first aspect of the present technique relating to a method for activating at least one functionality of a gateway equipment GW providing the interface between a wide area network WAN (typically the Internet network) and a local area network LAN, is presented in relation to FIG. 2. More particularly, the functionality or functionalities of the gateway equipment targeted by the activation method according to the proposed technique are functionalities related to the local area network LAN, in that they relate to the provision or configuration of such network. Examples of such functionality are given later in this document. The method is implemented by an electronic device DE connected to the wide area network WAN. As illustrated in FIG. 1, such an electronic device DE is for example integrated into or combined with a processing server SRVT connected to the wide area network WAN, or, alternatively, integrated into or combined with the gateway equipment GW.

In the context of the present technique, the electronic device DE has location information IL of at least one mobile communication terminal TC associated with the gateway equipment GW. In a particular embodiment corresponding to that illustrated in relation to FIG. 2, such location information IL is for example obtained in a step 21 of obtaining this information, implemented by the electronic device DE.

Mobile communication terminal “associated” with gateway equipment means here that the mobile communication terminal is already known to the gateway equipment or referenced to this gateway equipment, for example because this communication terminal TC has already connected in the past to the local area network LAN provided by the gateway GW (for example via a WiFi type wireless communication protocol, based on the IEEE 802.11 standard), and that this connection has been traced. In other words, in at least one data structure, an association exists between the mobile communication terminal TC and the gateway equipment GW.

The location information IL allows to estimate the geographic position, which is possibly approximate, of the communication terminal TC, either absolutely or relatively to the position of other equipment. As described later in different embodiments of the proposed technique, such location information IL can thus be in different forms.

In a step 22, when the location information IL is representative of a geographic proximity of the mobile communication terminal TC with the gateway equipment GW, the electronic device DE triggers the activation of at least one functionality of this gateway equipment. Optionally, before triggering such activation, the electronic device DE verifies that the functionality in question is indeed deactivated at the gateway equipment, for example by querying a database comprising this information.

Step 22 of activating at least one functionality of the gateway equipment can be in different forms, depending on the nature of the electronic device which implements the method according to the present technique.

Thus, when the electronic device is integrated into or combined with a processing server SRVT of the wide area network WAN, the activation step 22 is for example in the form of a step of transmitting, via this wide area network, a request for activating said at least one functionality, to the gateway equipment GW.

When the electronic device is alternatively integrated into or combined with the gateway equipment GW, the activation step 22 then consists more simply in generating at this device DE a command for activating said at least one functionality by gateway equipment GW.

According to the proposed technique, the functionalities of the gateway that thus may be activated by the electronic device DE, on the basis of data obtained via the wide area network WAN, are connected to the local area network LAN. Such functionalities may in particular comprise exiting a sleep state of the gateway equipment and/or activating at least one wireless access point, typically a Wi-Fi access point, at said gateway equipment. Exiting a sleep state allows to make the local area network LAN available, for example by globally activating a set of main functionalities of the gateway previously put to sleep in order in particular to limit its power consumption. The more targeted activation of at least one wireless access point aims, for example, at restoring the wireless communication capabilities of the local area network (the gateway then also provides a wireless local area network). The preceding examples are given for illustrative and non-limiting purposes, and other functionalities of the gateway GW may be the subject of the activation method according to the proposed technique.

In other words, according to the general principle of the present technique, it is proposed to activate automatically and transparently for the user, on the basis of data transmitted to the gateway equipment GW via the wide area network WAN (for example an activation request or location information), certain functionalities relating to the provision and/or configuration of the local area network LAN provided by said gateway, when it is detected that at least one mobile communication terminal referenced to the gateway is or becomes sufficiently close to the gateway. The geographic proximity of the mobile communication terminal to the gateway is indeed generally also representative of the presence near said gateway of the user possessing this terminal, that is to say of an individual likely to need to access the functionalities offered by the gateway. In this way, the obstacles that oppose the adoption by users of the energy saving mechanisms offered in gateway type equipment are removed, since the reactivation of functionalities previously deactivated in this context is carried out automatically and with full transparency, without the user having to carry out a dedicated action to initiate such a reactivation, and without the duration of the operation being perceptible to the user since the reactivation is in some way carried out in advance, in anticipation, before even the user has expressed a need to access the previously deactivated functionality. Moreover, when it relates to the automatic reactivation of wireless communication functionalities of the gateway equipment (typically Wi-Fi), another collateral advantage of the proposed technique can be observed from a more macroscopic point of view. Activation of the gateway as a Wi-Fi access point indeed leads to an automatic connection of the communication terminal to this access point (provided that it has already been connected thereto in the past, which is generally the case being a communication terminal and a domestic gateway of the same user or household). By this mechanism, the communication channel via Wi-Fi once again becomes the communication channel favored by the mobile communication terminal as long as it is close to the gateway, instead of the communication channel via the cellular network used by default in lack of Wi-Fi network. This has a beneficial effect by allowing an overall saving of resources, since it has been demonstrated that data exchanges (that is to say Internet traffic) implemented via a Wi-Fi communication channel are, when considered as a whole, less energy consuming than data exchanges implemented via the cellular network.

In the context of the present technique, at least two approaches can be adopted to establish the geographic proximity of a mobile communication terminal to the gateway equipment.

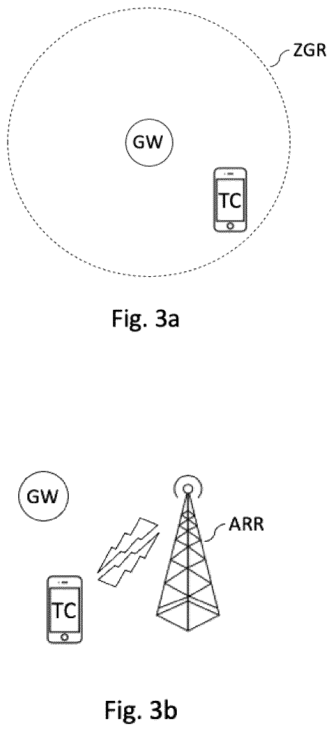

According to a first approach, the current geographic coordinates of the mobile communication terminal are used. Such coordinates are obtained for example via a satellite positioning system (for example GPS, Galileo, Glonass, etc.) and by means of a dedicated chip embedded in the terminal. Therefore, this involves comparing the position of the mobile communication terminal to the generally fixed position of the gateway equipment, on the basis of a geographic coordinate system. More particularly, according to a particular feature, the geographic proximity of the mobile communication terminal TC with the gateway equipment GW is confirmed when the geographic coordinates of the mobile communication terminal are representative of a presence of this terminal in a reference geographic zone which is previously determined, and associated with the gateway equipment. For example, as illustrated in FIG. 3a, the geographic reference zone ZGR can be in the form of a circular zone the center of which substantially corresponds to a geographic position of the gateway equipment GW, and the radius of which has been previously fixed (for example of the order of a few tens to a few hundred meters). Unlike the mobile communication terminal, the gateway is generally not equipped with a chip allowing it to be located by satellites. Also, the geographic coordinates of this equipment are for example entered manually in a graphical interface, or determined automatically (that is to say without intervention of a human operator, whether a user of the gateway equipment or an operator who markets it). Such automatic determination can be carried out on the basis of an address (for example postal address, IP address, etc.) associated with the gateway in a data structure (for example within a database administered by the operator who markets the gateway). According to a particular feature, the geographic reference zone can thus in particular be determined automatically, that is to say without specific manual human intervention, based on the address associated with the gateway equipment. Another alternative for automatically determining the geographic coordinates of the gateway equipment GW consists in considering that these coordinates correspond substantially to those of the communication terminal when it is connected to the local area network—and more particularly to the wireless local area network, typically to the Wi-Fi network—provided by the gateway equipment GW. In other words, it is considered that the geographic coordinates of the communication terminal connected to the local area network form a good approximation (or at least a sufficient approximation in the context of the present technique) of the geographic coordinates of the gateway equipment (for example for a first initialization of these coordinates). According to a particular feature, for such an approximation to be the best possible, the geographic coordinates retained for the gateway equipment are those of the communication terminal when it is detected that a radio signal received as part of the connection of this terminal to the wireless local area network provided by the gateway equipment GW reaches maximum power (for example when the RSSI, or “Received Signal Strength Indicator” is maximum).

According to a second approach, the position of the mobile communication terminal is determined, at least approximately, by identification of at least one relay antenna of a cellular network to which the communication terminal is currently attached (that is to say connected). Therefore, in this case the cellular communication interface of the mobile communication terminal, and its ability to connect to a cellular network (for example the cellular network CN illustrated in relation to FIG. 1) when it is in a coverage zone of at least one relay antenna of this network, are exploited to estimate its position. In this second approach, as illustrated in FIG. 3b, the geographic proximity of the mobile communication terminal TC with the gateway equipment GW is then established when a current attachment of the mobile communication terminal to at least one previously determined reference relay antenna ARR of the cellular network is detected. The reference relay antenna or antennas generally correspond to relay antennas close to the gateway equipment GW. Such reference relay antennas can for example be identified and selected manually in a dedicated graphical interface, or, alternatively, be identified automatically on the basis of an address (for example postal address, IP address, etc.) associated with the gateway in a data structure (for example within a database administered by the operator who markets the gateway). According to a particular feature, another alternative for automatically determining one or more reference relay antennas capable of being used subsequently to confirm the geographic proximity of a communication terminal with the gateway equipment GW consists in identifying the relay antenna(s) to which the communication terminal is attached when it is, simultaneously, connected to the local area network—and more particularly to the wireless local area network, typically to the Wi-Fi network—provided by the gateway equipment GW. These relay antennas are then selected as reference relay antennas.

In the context of the present technique, the approaches presented previously for determining whether the mobile communication terminal is geographically close or not to the gateway equipment can be implemented within different equipment, as detailed in the particular embodiments presented below.

In a first embodiment, the determination of the proximity of the mobile communication terminal with the gateway equipment is implemented by the mobile communication terminal TC itself, for example in the context of the execution of a dedicated application on the mobile communication terminal, specifically designed to implement either one of the two approaches previously presented. In this case, a geographic reference zone and/or at least one reference relay antenna are for example stored in a memory of the mobile communication terminal, or in a data structure accessible from this terminal for example via a connection to the cellular network. Also, in this first embodiment, the location information IL obtained by the electronic device in step 21 is in the form of data indicative of proximity, received by the electronic device from the communication terminal, confirming the geographic proximity of the mobile communication terminal TC with the gateway equipment GW. In such an embodiment, the electronic device therefore directly receives, via the wide area network WAN (possibly via one or more intermediate servers of this wide area network), the information that the mobile communication terminal is close to the gateway equipment, and it can implement the activation step 22 without the need to carry out additional verifications.

In other embodiments, the determination of the proximity of the mobile communication terminal to the gateway equipment is implemented by the electronic device DE.

Thus, in a second particular embodiment, the location information IL obtained by the electronic device DE in step 21 is in the form of geographic coordinates (for example GPS coordinates) of the mobile communication terminal TC, received by the electronic device coming from the mobile communication terminal via the wide area network WAN (possibly via one or more intermediate servers of this wide area network). In such an embodiment, the electronic device DE therefore itself implements the first approach previously presented, and the activation step 22 is conditional on the verification, by the electronic device DE, that the current geographic coordinates of the mobile communication terminal are representative of a presence of this terminal in the geographic reference zone previously determined and associated with the gateway equipment GW.

According to a similar principle, in a third particular embodiment, the location information IL obtained by the electronic device DE in step 21 is in the form of data representative of a current attachment of the mobile communication terminal TC to at least one relay antenna of known geographic position within a cellular network comprising said at least one relay antenna. Such data can be received by the electronic device from the mobile communication terminal itself, via the wide area network WAN (possibly through one or more intermediate servers of this wide area network), or obtained from another equipment of the wide area network, typically third-party equipment from a cellular network operator (such an operator having by nature easy access to this type of information). In this third embodiment, the electronic device DE therefore itself implements the second approach previously presented, and the activation step 22 is conditional on the verification, by the electronic device DE, that the data obtained are representative of a current attachment of the mobile communication terminal to at least one previously determined reference relay antenna of the cellular network (that is to say to a relay antenna a priori close to the gateway equipment GW).

According to another aspect, the present technique also relates to an electronic device for activating at least one functionality of gateway equipment providing the interface between a wide area network and a local area network, this electronic device being capable of implementing the method previously described in any of its embodiments. Such an electronic device is for example under the control of an operator who markets the gateway equipment, in addition to possibly administering a cellular network. The electronic device is connected to the wide area network, and the functionality that it allows to activate (for example wake-up, Wi-Fi activation) is connected to the local area network provided by the gateway equipment. More particularly, such an electronic device comprises means for activating said at least one functionality related to the local area network, which are implemented when location information from at least one mobile communication terminal associated with the gateway equipment is representative of a geographic proximity of said mobile communication terminal with said gateway equipment.

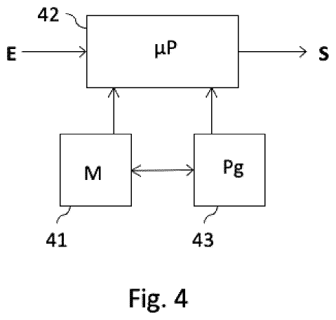

FIG. 4 represents, in a schematic and simplified manner, the structure of such an electronic device, in a particular embodiment. This electronic device is for example integrated into or combined with a processing server connected to the wide area network, or, alternatively, integrated into or combined with the gateway equipment.

The electronic device according to the proposed technique comprises for example a memory 41 consisting of a buffer memory M, a processing unit 42, equipped for example with a microprocessor μP, and controlled by the computer program Pg 43, implementing the activation method according to the development.

Upon initialization, the code instructions of the computer program 43 are loaded into the buffer memory before being executed by the processor of the processing unit 42. The processing unit 42 receives at input E location information of at least one mobile communication terminal associated with gateway equipment.

The microprocessor of the processing unit 42 then carries out the steps of the method previously described, according to the instructions of the computer program 43, to deliver at the output S a command for activating at least one functionality of the gateway equipment. When the electronic device is integrated into or combined with a processing server, the output S is for example in the form of a request for activating said at least one functionality, which is transmitted to the gateway equipment via the wide area network (for example by means of a network interface—for example an Ethernet card—comprised in the electronic device). More particularly, depending on the implemented embodiment, the microprocessor 42 obtains either confirmation that the communication terminal is in geographic proximity to the gateway equipment (in which case it directly emits the activation command at the output S), or data allowing it to evaluate itself whether the communication terminal is in geographic proximity or not to the gateway equipment (in which case the emission at the output S of the activation command is conditional on the prior verification that such proximity exists).

1. A method for activating at least one functionality of gateway equipment providing the interface between a wide area network and a local area network, the functionality being related to the local area network, wherein the method comprises, at an electronic device connected to the wide area network, an activation via the wide area network of the at least one functionality related to the local area network, when location information from at least one mobile communication terminal associated with the gateway equipment is representative of a geographic proximity of the mobile communication terminal with the gateway equipment.

2. The method according to claim 1, wherein the functionality belongs to a group comprising:
an exit from a sleep state of the gateway equipment; and/or
an activation of at least one wireless access point at the gateway equipment.

3. The method according to claim 1, wherein the location information is in the form of data indicative of proximity, received by the electronic device from the communication terminal, confirming the geographic proximity of the mobile communication terminal with the gateway equipment.

4. The method according to claim 1, wherein the location information is in the form of geographic coordinates of the mobile communication terminal received by the electronic device from the mobile communication terminal, and in that the geographic proximity of the mobile communication terminal with the gateway equipment is established by the electronic device when the geographic coordinates are representative of a presence of the mobile communication terminal in a geographic reference zone previously determined and associated with the gateway equipment.

5. The method according to claim 4, wherein the geographic reference zone is determined automatically based on an address associated with the gateway equipment.

6. The method according to claim 4, wherein the geographic reference zone is a circular zone a center of which corresponds to a geographic position of the gateway equipment, and a radius of which is previously determined.

7. The method according to claim 1, wherein the location information is in the form of data representative of a current attachment of the mobile communication terminal to at least one relay antenna of known geographic position within a cellular network comprising the at least one relay antenna, received by the electronic device from the communication terminal or from third-party equipment of an operator of the cellular network, and in that the geographic proximity of the mobile communication terminal with the gateway equipment is established by the electronic device when the data are representative of a current attachment of the mobile communication terminal to at least one previously determined reference relay antenna of the cellular network.

8. The method according to claim 7, wherein the at least one reference relay antenna is determined automatically based on an address associated with the gateway equipment and/or based on a prior identification of at least one relay antenna to which the mobile communication terminal is attached when the mobile communication terminal is connected to a wireless local area network provided by the gateway equipment.

9. An electronic device for activating at least one functionality of gateway equipment providing an interface between a wide area network and a local area network, the electronic device being connected to the wide area network and the functionality being related to the local area network, wherein the electronic device comprises means for activating the at least one functionality related to the local area network, implemented when location information from at least one mobile communication terminal associated with the gateway equipment is representative of a geographic proximity of the mobile communication terminal with the gateway equipment.

10. A mobile communication terminal associated with gateway equipment providing an interface between a wide area network and a local area network, wherein the mobile communication terminal is configured to transmit to an electronic device according to the claim 9 location information representative of a geographic proximity of the mobile communication terminal with the gateway equipment.

11. A computer program downloadable from a communication network and/or stored on a non-transitory computer-readable medium and/or executable by a microprocessor, it wherein the computer program comprises program code instructions for executing the method for activating at least one functionality of gateway equipment according to claim 1, when executed by the microprocessor.
